(19) United States
(12) Patent Application Publication
(10) Pub. No.: US 2005/0177777 A1
(43) Pub. Date: Aug. 11, 2005

(54) Cluster-based disk backup and restoration

(76) Inventors: Gunnar Paul Seaburg, The Woodlands, TX (US); Tri Minh Nguyen, Cypress, TX (US); Christoph Graham, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/763,492

(22) Filed: Jan. 23, 2004

(51) Int. Cl. G06F 11/00

(52) U.S. Cl. 714/42

(57) ABSTRACT

Systems, methodologies, media, and other embodiments associated with cluster-based partition backup and restoration are described. One exemplary system embodiment includes a logic for handling metadata that describes a partition on a hard disk drive, where the partition may be backed up onto the hard disk drive and/or restored from the hard disk drive. The example system may also include a logic for handling data transfers to and/or from the partition to be backed up and/or restored and a cluster-based backup image stored on the hard disk drive.

### BACKGROUND

Sometimes computer users may want to have their operating system, file system, applications, and/or data re-installed, or reset to their original factory settings. Additionally and/or alternatively, a computer user may want to backup and/or restore a partition on a hard disk drive. To perform a restore, conventionally, a user may install a “boot disk” to boot the target computer and then reinstall from a set of disks. The operating system, applications, and so on may be reinstalled on a file by file basis using file system programs, data structures, and so on. These file system processes, data structures and so on, are typically designed for file system specific special purposes and thus may examine directory trees, manipulate file allocation tables (FATs), check file protections, search for free space, attempt to optimize directory structures, and so on, all of which take processing cycles and thus time.

Being able to restore from a set of disks presupposes that a set of disks from which the restore can proceed exists. Thus, conventional restore systems are typically associated with a backup system for creating the set of disks from which the reinstall can occur. The backup system may be employed “at the factory” (e.g., before a system is shipped) and/or later (e.g., on a user driven timetable). Like the restore systems and methods, the backup systems and methods may use file system programs, data structures, and so on, and thus may experience the same processing time issues.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example cluster-based backup method.

FIG. 2 illustrates another example cluster-based backup method.

FIG. 3 illustrates an example cluster-based restoration method.

FIG. 4 illustrates another example cluster-based restoration method.

FIG. 5 illustrates an example system for performing cluster-based backups and/or restores.

FIG. 6 illustrates an example computing environment in which example systems and methods illustrated herein can operate.

FIG. 7 illustrates an example image forming device in which example systems and methods illustrated herein can operate.

FIG. 8 illustrates an example application programming interface (API).

### DETAILED DESCRIPTION

This application describes systems, methods, and so on associated with backing up and/or restoring a hard drive partition. The example systems and methods perform cluster-based reads and/or writes of a partition rather than performing conventional file by file, file system processes on conventional data structures like files and so on. The example systems and methods employ a “backup partition” on a hard drive rather than external media for storing the backup/restore image. A cluster-based backup image may be placed on the hard drive “at the factory” before a computer is shipped. The cluster-based backup image may be placed, for example, in a separate partition from the partition being backed up on the hard drive and/or in a file in the partition being backed up on a hard drive. A cluster-based restore program may restore the user partition to its original state by doing cluster-based reads from the backup image and cluster-based writes to the partition to be restored, again without employing some conventional file system processes and data structures (e.g., files, directories).

Hard disk drives in computer systems (e.g., personal computers (PCs), servers) typically store data (bytes) in sectors (e.g., 512 bytes). A file system may then track which sectors are used by files. For a large drive (e.g., 40 GB), a file system may therefore track a large number of sectors (e.g., 83,886,080 sectors). Thus, sectors may be grouped into “clusters” (e.g., groups of contiguous sectors) and the file system may track these clusters rather than sectors. In the FAT32 file system, a cluster size may be 16 Kb (32 sectors). In the NTFS, a cluster size may default to 4 Kb (8 sectors). Tracking by clusters facilitates reducing file system overhead but wastes space because a file, no matter how small, is likely to be allocated an entire cluster.

Regardless of the tradeoff between file system overhead and wasted space, data structures are populated with information about allocated clusters. For example, a volume bitmap may record which clusters contain data and which clusters are unallocated. Thus, the example systems and methods described herein may access the volume bitmap to determine which clusters to back up, and then use Windows® XP Pre-Install Environment (WinPE) processes to do cluster level reads and writes. In one example, the volume bitmap includes one bit per cluster on a hard drive. If the bit is set (e.g., 1), then the cluster is allocated and contains data to be backed up. If the bit is clear (e.g., 0), then the cluster is unallocated and does not need to be backed up. In one example, the volume bitmap can itself be stored in the backup image, to facilitate recreating a substantially exact image during a restore process. In the NTFS, the volume bitmap may include information about NTFS structures. But in the FAT32 system, the volume bitmap may not track FATs, and thus FAT data may need to be discovered and backed up separately.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

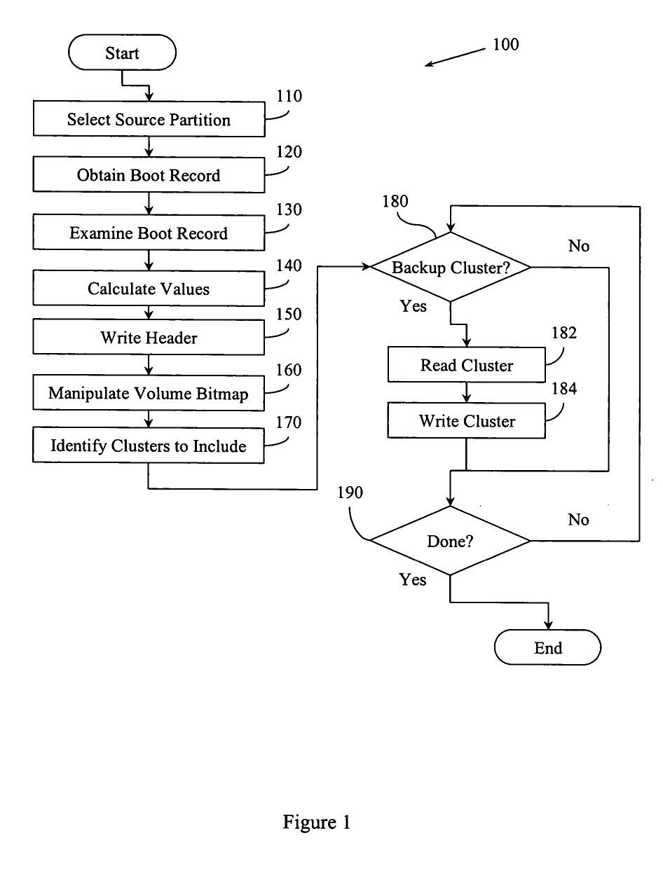

Example methods may be better appreciated with reference to the flow diagrams of FIGS. 1 through 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates an example computerized cluster-based backup method 100. The method 100 may include, at 110, selecting a source partition (e.g., partition to be backed up) on a hard disk drive. A cluster-based backup image of the source partition will be produced and stored by the method 100 in a target partition on the hard disk drive. Thus, both the source partition (the partition to be backed up), and the target partition (the partition in which the cluster-based backup image will be written) are located on the same hard disk drive. In one example, the target partition may be located in the source partition, while in another example, the target partition is not located in the source partition. Thus, a cluster-based backup image may be stored in an otherwise inaccessible space on a user hard drive. The otherwise inaccessible space may be, for example, on a D drive (e.g., a second partition on a hard drive with a C drive) and/or on a “ghost” file located in the C drive. “Ghost file” and “ghost partition”, as used herein, refer to entities similar to those described in U.S. Pat. No. 5,974,567. For example, a ghost file may be a regular file that resides in a ghost partition. In one example, a ghost partition may be wrapped into a file so that a user and/or file system will not inadvertently overwrite the clusters associated with the ghost file. Furthermore, if a ghost partition is wrapped in file, then the file may be made non-relocatable by making it, for example, a read-only hidden system file. Wrapping a ghost partition in a file and making the file non-relocatable facilitate resolving issues associated with unintended overwriting of ghost partitions and/or files. A restore system or method can use knowledge of the location of the data clusters in the backup image to facilitate bypassing some file system specific calls, which can reduce the time required to do a restore when compared to a file by file based approach. In one example, WinPE functionality facilitates gathering cluster information and performing cluster-based acts like identifying a used cluster, reading a cluster, writing a cluster, and so on. These “lower level” (e.g., cluster based vs. file system based) WinPE processes facilitate not using “higher level” Windows® processes that may be more file system oriented and thus slower. In one example, the cluster-based backup image may be created at a rate of more than five hundred megabytes per minute. While five hundred megabytes per minute are described, it is to be appreciated that other speeds can be employed.

The method 100 may also include, at 120, obtaining a boot record for the source partition. In one example, the boot record may be obtained by reading the first sector from the source partition. The method 100 may also include, at 130, examining the boot record to determine values for file system parameters (e.g., a file system type, a file system size, and a cluster size) for a file system stored in the source partition. Some example systems and methods may employ the WinPE environment and support Windows NT file system (NTFS) and/or FAT32 file systems while avoiding general purpose Windows XP file system calls. Thus, the file system may be, for example, an NTFS file system and/or a FAT32 file system.

The WinPE environment may also provide other functionalities. For example, the WinPE environment may provide APIs to processes that facilitate discovering disk partition layout, determining partition areas that contain data (e.g., used clusters) by querying a partition volume bitmap structure, and so on. These WinPE APIs may facilitate using WinPE processes to manipulate disk clusters in sequential on-disk order, from the beginning of the drive to the end, which may facilitate avoiding hard disk seek and latency times associated with file system based per file reading and writing. Additionally, backup and restore methods may use memory caching mechanisms to minimize seeks between user and backup areas.

The method 100 may also include, at 140, calculating a value(s) for a source partition metadata parameter(s) from the file system parameters and/or source partition parameters. The source partition metadata parameters may store data concerning, for example, the source partition size, location, name, type, cluster-size, and so on.

The method 100 may also include, at 150, writing a cluster-based backup image header data structure to the target partition. The cluster-based backup image header data structure may store data including, but not limited to, source partition metadata parameters, file system parameters, and source partition parameters. In one example, the cluster-based backup image header data structure stores a header length field, a format version field, an image backup file name field, a partition cluster count field, a backup image cluster count field, a volume bitmap bit count field, a cluster size field, a sector size field, and a partition type field. While nine fields are described, it is to be appreciated that cluster-based backup image header data structures with a greater and/or lesser number of fields may be employed.

Not every file in a partition for which a cluster-based backup image will be produced may be included in the cluster-based backup image. For example, if the partition includes a cluster-based backup image, then it may not be desired to make a backup image of the backup image. Thus, the method 100 may include, at 160, selectively manipulating bits in a volume bitmap associated with the source partition. The bits may be associated with files that are not to be included in the cluster-based backup image. For example, the bits may be associated with files like a hiberfil.sys file, a pagefile.sys file, and a ghost file.

The method 100 may also include, at 170, identifying clusters in the source partition to be included in the cluster-based backup image. The clusters may be identified, for example, by accessing the volume bitmap. In one example, the volume bitmap may be accessed using functionality provided through a call like DeviceIoControl( . . . , FSCTL_GET_VOLUME_BITMAP, . . . ). At 180, a determination is made concerning whether a particular cluster is to be backed up. If the determination at 180 is Yes, then at 182 a cluster is read from the source partition and, at 184, is written to the cluster-based backup image. At 190, a determination is made concerning whether there are more clusters to be considered for writing to the cluster-based backup image. If the determination is Yes, then processing returns to 180, otherwise processing may conclude.

Various actions undertaken by method 100 may be accomplished using functionality provided by the WinPE environment. Thus, in one example, a boot record may be obtained and/or examined using a WinPE process. Similarly, the cluster-based backup image header data structure may be written to the target partition using a WinPE process and the volume bitmap may be accessed using a WinPE process. Likewise, a cluster may be read from the source partition using a WinPE process and a cluster may be written to the cluster-based backup image using a WinPE process. While WinPE processes are described, it is to be appreciated that other environments that provide cluster-based reads, writes, and so on may be employed.

While FIG. 1 illustrates various actions occurring in serial, it is to be appreciated that various actions illustrated in FIG. 1 could occur substantially in parallel. By way of illustration, a first process could select a partition to be backed up and gather information about the partition (e.g., its metadata). Similarly, a second process could create the backup image header(s) and/or metadata data structures, while a third process could manipulate the volume bitmap, identify clusters, and control reading and writing the clusters to the cluster-based backup image. While three processes are described, it is to be appreciated that a greater and/or lesser number of processes could be employed and that lightweight processes, regular processes, threads, and other approaches could be employed.

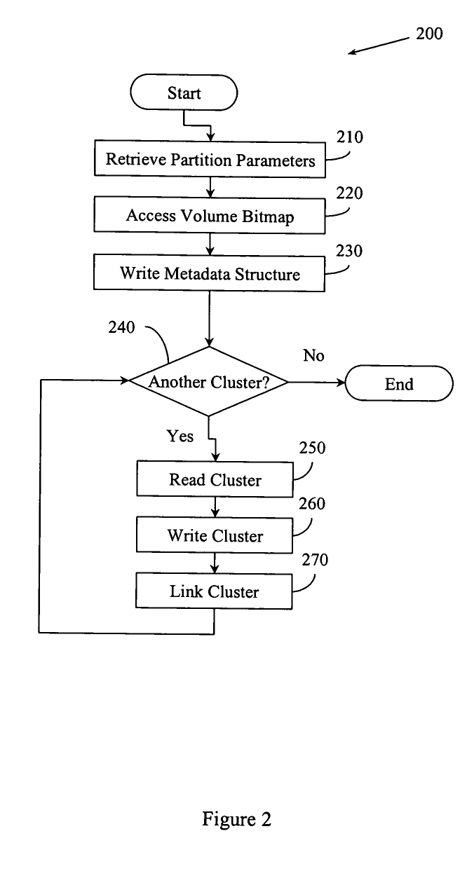

FIG. 2 illustrates another example computerized method 200 for producing a cluster-based backup image of a source partition on a hard disk drive. The method 200 may include, at 210, retrieving source partition parameters from a boot data structure associated with the source partition. The source partition parameters may include, for example, a file system type, a file system size, and a cluster size. The boot data structure may be, for example, a boot record. While three source partition parameters are described, it is to be appreciated that a greater and/or lesser number of source partition parameters may be acquired and/or written.

The method 200 may also include, at 220, accessing a volume bitmap associated with the source partition to facilitate identifying clusters to be included in the cluster-based backup image. The volume bitmap may be accessed, for example, using WinPE functionality. The WinPE functionality may be invoked, for example, by using processes available through a WinPE API. The method 200 may also include, at 230, writing to a target partition a cluster-based backup image metadata data structure configured to store partition metadata. Thus, the cluster-based backup image may contain clusters read from the source partition and data about those clusters and the image being created.

The method 200 may also include, at 250 through 270, producing the cluster-based backup image. In one example, at 240, a determination is made concerning whether there is another cluster to add to the cluster-based backup image. If the determination at 240 is No, then processing can conclude. But if the determination is Yes, then at 250 the method 200 may include selectively reading a cluster based, at least in part, on information stored in the volume bitmap. For example, if a volume bitmap bit is set (e.g., 1), then the cluster may be read but if the volume bitmap bit is clear (e.g., 0), then the cluster may not be read. After a cluster is read, the method 200 includes, at 260, writing the cluster to the target partition. But a cluster-based backup image may not be simply a set of clusters in a partition. Information about the clusters may be stored in a data structure(s) associated with the set of clusters. Therefore method 200 may include, at 270, linking a cluster written to the target partition to the cluster-based backup image metadata data structure to facilitate restoring the source partition from the target partition. The linking may be accomplished by, for example, writing a cluster source identifier, a cluster destination identifier, a cluster number, and so on to the metadata data structure. The metadata data structure may also be updated with, for example, a count of the number of clusters written to the cluster-based backup image.

Like method 100 may employ functionality provided by the WinPE environment, so too may method 200. Thus, in one example, the volume bitmap may be accessed using a WinPE process and clusters may be read and/or written using WinPE processes. In one example, the target partition to which the cluster-based backup image is written is in the source partition while in another example the target partition is not in the source partition.

While FIG. 2 illustrates various actions occurring in serial, it is to be appreciated that various actions illustrated in FIG. 2 could occur substantially in parallel. By way of illustration, a first process could retrieve partition parameters, access the volume bitmap and store a metadata data structure in the target partition. Similarly, a second process could read clusters from the source partition, a third process could write clusters to the target partition and a fourth process could link written clusters to the metadata data structure. While four processes are described, it is to be appreciated that a greater and/or lesser number of processes could be employed and that lightweight processes, regular processes, threads, and other approaches could be employed.

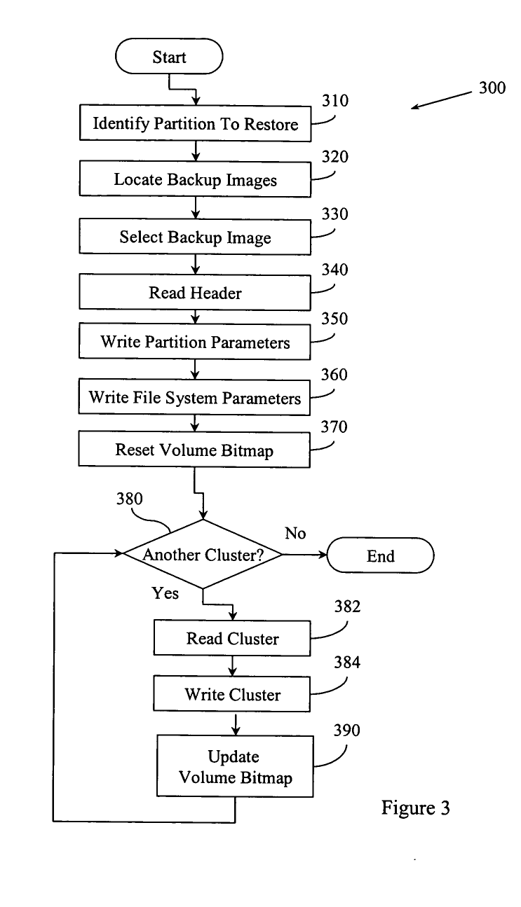

FIG. 3 illustrates an example computerized cluster-based partition restoration method 300. The method 300 may include, at 310, identifying a partition to restore on a hard disk drive. The partition may be a partition that a user desires to have restored to its “original factory settings”. For example, a user may have tried to update an operating system registry and in so doing corrupted one or more files, links, data structures, applications and so on in a partition. The user may not be able to undo their actions and thus may want to start over with the computer configured the way it was the day it arrived. Conventionally, a partition may be restored from a set of compact disks and/or floppy drives. However, such a conventional technique may take hours and many user interactions. But if there is a cluster-based backup image available on the hard drive housing the partition to be restored, a cluster-based backup restoration method may be employed. This may facilitate, for example, performing the restoration more quickly. In one example, the restoration may be accomplished in less than five minutes and require fewer user interactions.

Thus, the method 300 may include, at 320, locating a cluster-based backup image(s) from which the partition can be restored. The cluster-based backup image(s) from which the partition can be restored is located on the hard disk drive having the partition to be restored. The method 300 may also include, at 330, selecting a cluster-based backup image from which the partition will be restored. In some examples a restoration method may be configured to look for a single cluster-based backup image in a known location and thus actions performed at 320 and 330 may reflect the search for the single cluster-based backup image.

The method 300 may also include, at 340, reading a cluster-based backup image header data structure from the cluster-based backup image. The header data structure may store, for example, partition parameters, file system parameters, and the like. In one example, partition parameters may include, but are not limited to, a partition type, a partition size, a partition location, a partition name, and so on. In another example, file system parameters include, but are not limited to, a file system type, a file system size, a cluster size, and so on.

A hard disk drive partition may be associated with a boot record. Thus, the method 300 may include, at 350, writing partition parameters to a boot record associated with the partition and at 360 writing file system parameters to the boot record associated with the partition. Similarly, information about a partition (e.g., clusters in use) may be stored in a volume bitmap. Therefore, method 300 may also include, at 370, resetting bits on a volume bitmap associated with the partition being restored. Thus, it is to be appreciated that a cluster-based backup image restoration process may include not only copying clusters of data, but also creating and/or populating data structures like a boot record and/or volume bitmap associated with the partition being restored.

With supporting data structures created, the method 300 may then proceed to read clusters from the cluster-based backup image and write them to the partition to be restored. Therefore, method 300 may include, at 380, making a determination whether there is another cluster to be read from the cluster-based backup image. If the determination at 380 is No, then processing may conclude. But if the determination is Yes, then at 382, a cluster may be read as a cluster from the cluster-based backup image and, at 384, be written to the partition as a cluster. As described above, data about a partition may be stored. Therefore, the restoration method 300 may include, at 390, updating the volume bitmap to include the written cluster in a set of active clusters in the partition.

In one example, the method 300 is performed in the WinPE environment. Therefore, actions like reading the cluster-based backup image header data structure, writing the partition parameters to the boot record, writing the file system parameters to the boot record, resetting the bits in the volume bitmap, reading a cluster, and writing a cluster may be performed using a WinPE process. The WinPE process may be invoked through a WinPE API entry point like DeviceloControl( . . . , FSCTL_GET_VOLUME_BITMAP, . . . ). In one example, the method 300 may be employed to restore partitions that store various file systems. For example, the partition to restore may include an NTFS file system, a FAT32 file system, and the like.

While FIG. 3 illustrates various actions occurring in serial, it is to be appreciated that various actions illustrated in FIG. 3 could occur substantially in parallel. By way of illustration, a first process could identify a partition to restore, a second process could locate backup images and make ready to restore from the backup images, a third process could establish and/or populate data structures associated with the partition to restore, a fourth process could read clusters, a fifth process could write clusters, and a sixth process could update the volume bitmap based on the writing. With substantially parallel processing occurring, cache mechanisms could be employed to mitigate the effects of seek and latency times. While six processes are described, it is to be appreciated that a greater and/or lesser number of processes could be employed and that lightweight processes, regular processes, threads, and other approaches could be employed.

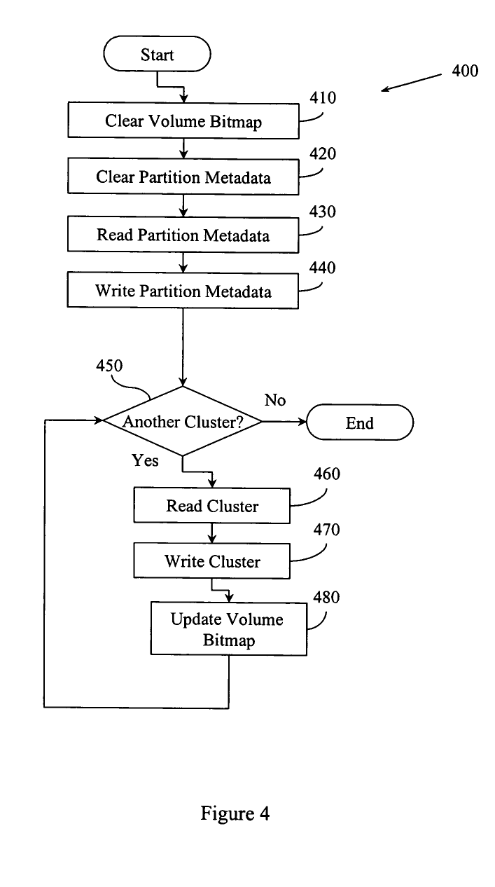

FIG. 4 illustrates an example computerized method 400 for restoring a partition on a hard disk drive from a cluster-based backup image stored on the hard disk drive. The method 400 may include, at 410, clearing a volume bitmap associated with the partition to be restored. The volume bitmap may be maintained by an operating system (e.g., Windows XP) to track which clusters in a partition on a hard disk drive are in use. Since the cluster based restoration method 400 will be writing clusters to the partition to restore, the action at 410 can facilitate starting with a logically clear partition to which clusters from the cluster-based backup image can be written. Thus, the method 400 may also include, at 420, clearing a partition metadata data structure (e.g., boot record) associated with the partition to be restored.

With the volume bitmap reset and partition metadata data structure(s) prepared, the method 400 may proceed, at 430, to read a partition metadata parameter value(s) from the cluster-based backup image and, at 440, to write the partition metadata parameter value(s) to the partition metadata data structure. For example, partition metadata like a partition name, size, creation date, creation time, creation entity, cluster size, file system(s) supported, and so on may be read from the cluster-based backup image and stored in the partition metadata data structure. While seven parameters are described, it is to be appreciated that a greater and/or lesser number of parameters of various types can be employed. For example, since a partition may include various file systems like an NTFS file system or a FAT32 file system, a parameter describing a file system type may be included.

A cluster-based backup image may include more than one cluster. Indeed it is likely to contain several thousand clusters. Thus, at 450, a determination is made concerning whether there is another cluster to read from the cluster-based backup image. If the determination is No, then processing can conclude. But if the determination is Yes, then the method 400 can include, at 460, reading a cluster from the cluster-based backup image, and at 470, writing the cluster to the partition to be restored. Since an operating system (e.g., Windows XP) may store information about a partition, the method 400 may include, at 480, updating the volume bitmap to include the cluster written to the partition to be restored as part of the restored partition. Thus, in addition to reading the image data in from the cluster-based backup image as clusters, the method 400 may also update values in various data structures (e.g., volume bitmap, boot record) while restoring a partition. The clusters may be read and/or written, and the various data structures created and/or manipulated using, for example, functionality provided by the WinPE environment.

In one example, the method 400 may restore the partition to be restored from a cluster-based backup image located in the partition to be restored. In another example, the method 400 may restore the partition to be restored from a cluster-based backup image stored in a different partition on the same hard disk drive.

While FIG. 4 illustrates various actions occurring in serial, it is to be appreciated that various actions illustrated in FIG. 4 could occur substantially in parallel. By way of illustration, a first process could prepare operating system and/or file system data structures like a boot record and/or volume bitmap. Additionally, a second process could read clusters from a cluster-based backup image, while a third process could write the clusters to the partition to be restored and report them to the operating and/or file system via the data structures. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes selecting a source partition on a hard disk drive, for which a cluster-based backup image of the source partition will be produced and stored in a target partition on the hard disk drive. The method may also include obtaining a boot record for the source partition using a WinPE process and examining the boot record using a WinPE process to determine a value for parameters like, a file system type, a file system size, and a cluster size associated with a file system stored in the source partition. The method may also include calculating values for source partition metadata parameters from source partition parameters, the file system type, the file system size, the cluster size, and so on. The method may also include writing a cluster-based backup image header data structure to the target partition using a WinPE process, where the cluster-based backup image header data structure includes parameters like, the source partition metadata parameters, the source partition parameters, the file system type, the file system size, the cluster size, and so on. The method may also include selectively manipulating, using a WinPE process, a bit(s) in a volume bitmap associated with the source partition, where the bit(s) is associated with a file(s) that is not to be included in the cluster-based backup image and then identifying, by accessing the volume bitmap, clusters in the source partition to be included in the cluster-based backup image. With the clusters identified, the method may also include, for the identified clusters, reading a cluster, as a cluster, from the source partition, using a WinPE process and writing the cluster, as a cluster, to the cluster-based backup image, using a WinPE process. While the above method is described being stored on a computer-readable medium, it is to be appreciated that other example methods described and claimed herein can also be stored on a computer-readable medium.

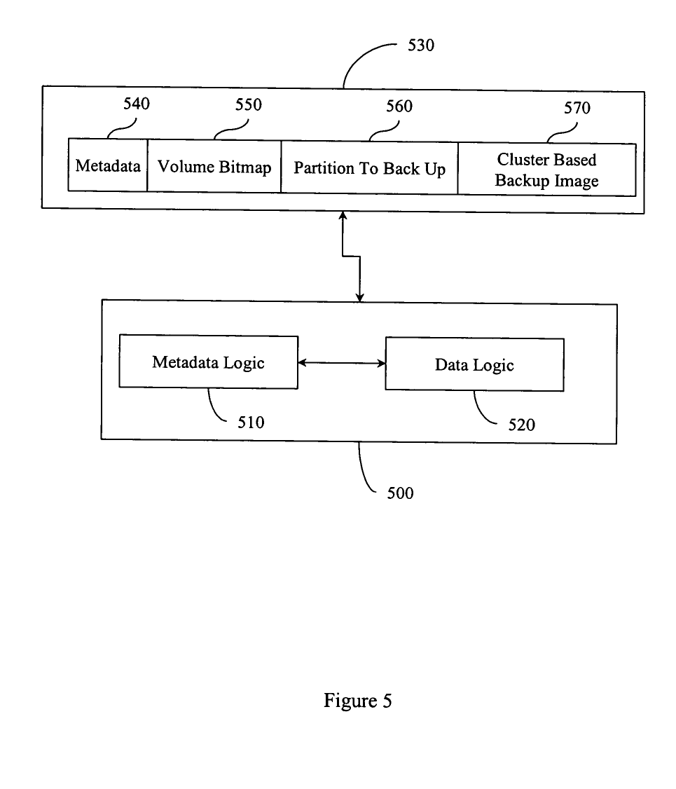

FIG. 5 illustrates an example system 500 for performing cluster-based backups and/or restores. The system 500 includes a metadata logic 510 and a data logic 520 that facilitate interacting with a hard disk drive 530 and that facilitate creating and/or restoring from a cluster-based backup image 570. The system 500 may be temporarily, permanently, and/or removably operably connected to the disk drive 530.

The metadata logic 510 may be configured to acquire disk drive metadata 540 that describes, for example, a hard disk drive partition 560 to be backed up. The metadata 540 may include, for example, cluster information (e.g., size, number), file system information (e.g., type, number, size), partition data (e.g., creation date, size, location), operating system information, and so on. The metadata logic 510 can be configured to write the metadata 540 and/or selected copies of portions thereof to the cluster-based backup image 570 from which the hard disk drive partition can be restored. Additionally, and/or alternatively, the metadata logic 510 can be configured to read metadata from the cluster-based backup image 570 and update the metadata 540 on the hard disk drive 530 during, for example, a restore operation.

The data logic 520 may be configured to access a volume bitmap 550 associated with the hard disk drive partition 560 to be backed up. The volume bitmap 550 may be maintained by an operating system like Windows XP. The volume bitmap 550 can be accessed and information from the volume bitmap 550 may be stored in a portion of the cluster-based backup image 530. The data logic 520 can also be configured to selectively read clusters identified in the volume bitmap 550 as being allocated to the hard disk drive partition to be backed up 560 and to write the clusters to the cluster-based backup image 570. The data logic 520 may also be configured to read clusters from the cluster-based backup image 570 during, for example, a restore operation.

In one example, the data logic 520 writes the cluster-based backup image 570 in the same partition on the disk drive 530 as the partition 560 to be backed up. In another example, the data logic 520 writes the cluster-based backup image 570 in a partition separate from the partition 560 to back up. Thus, the system 500 may produce the cluster-based backup image 570 to backup the partition 560 and/or may restore a partition to restore (not illustrated) from the cluster-based backup image 570. While creating a cluster-based backup image 570 and/or restoring from the cluster-based backup image 570, the system 500 may read and/or write to data structures that store metadata 540 (e.g., a boot record), cluster usage information (e.g., volume bitmap 550) and so on.

Thus, the system 500, with metadata logic 510 and data logic 520 implemented as ASICs, programs, applications, specifically programmed microprocessors, and so on, may serve as means for identifying a partition on a hard disk drive for which a cluster-based backup image is to be written onto the hard disk drive, means for acquiring and writing to the cluster-based backup image a partition metadata that describes the partition on the hard disk drive, and means for acquiring and writing to the cluster-based backup image a partition data that has a cluster(s) in the partition on the hard disk drive. Similarly, the system 500, with metadata logic 510 and data logic 520 implemented as ASICs, programs, applications, specifically programmed microprocessors, and so on, may serve as means for identifying a cluster-based backup image on a hard disk drive from which a partition on the hard disk drive can be restored, means for acquiring and writing a cluster-based backup image partition metadata to the partition to be restored, and means for acquiring and writing to the partition to be restored a partition data that includes a cluster(s) stored in cluster-based backup image.

In one example, data structures may be constructed that facilitate storing data on a computer-readable medium and/or in a data store. Thus, in one example, a computer-readable medium may store a data structure that includes a first field containing data that forms and/or represents a cluster-based image from which a partition on a hard disk drive can be restored. The data structure may also include, for example, a second field that that stores metadata that describes the cluster-based image stored in the first field. Thus, the data structure may store the data that forms the image, and data about the image. While two fields are described, it is to be appreciated that a greater and/or lesser number of fields could be employed.

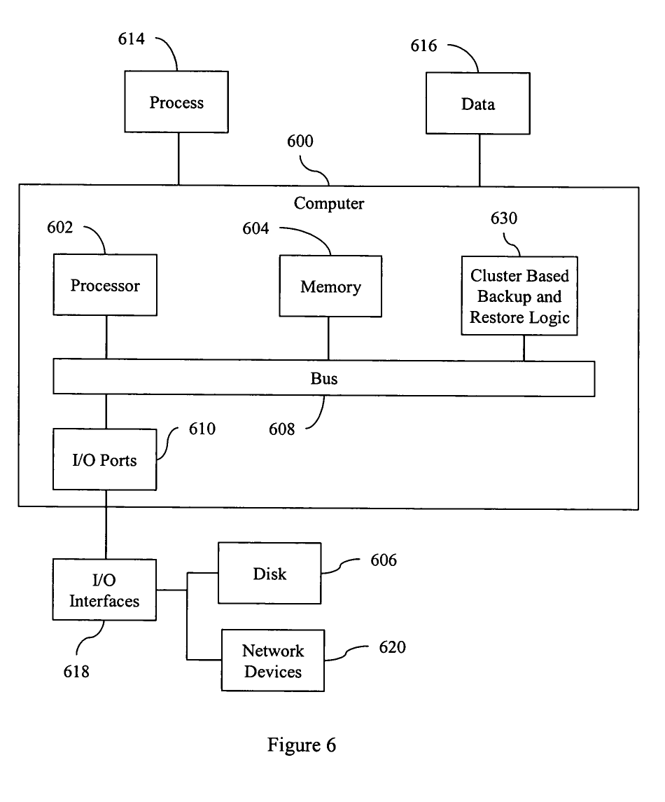

FIG. 6 illustrates a computer 600 that includes a processor 602, a memory 604, and input/output ports 610 operably connected by a bus 608. In one example, the computer 600 may include a cluster-based backup and restore logic 630 configured to facilitate producing a cluster-based backup image and/or restoring a partition from the cluster-based backup image. For example, disk 606 may include a partition that a user wants to back up. The cluster-based backup and restore logic 630 can control performing cluster based reads and writes to back up the partition on disk 606 in a cluster-based backup image on disk 606.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

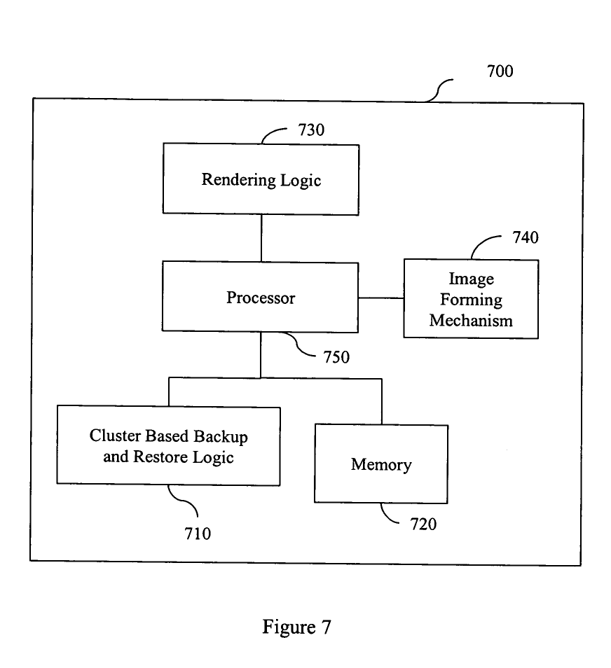

FIG. 7 illustrates an example printer 700 that includes a cluster-based backup and restore logic 710. The logic 710 may be configured to perform example executable methods like those described herein. The logic 710 may be permanently and/or removably attached to the printer 700.

The printer 700 may receive print data to be rendered. Thus, printer 700 may also include a memory 720 configured to store print data or to be used more generally for print image processing. Similarly, the printer 700 may include a disk drive (not illustrated). Thus, the cluster based backup and restore logic 710 may control producing a cluster-based backup image of a partition on the disk drive and/or restoring a partition on the disk drive from a cluster-based backup image.

The printer 700 may also include a rendering logic 730 configured to generate a printer-ready image from print data. Rendering varies based on the format of the data involved and the type of imaging device. In general, the rendering logic 730 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the printer 700 may receive printer-ready data that does not need to be rendered and thus the rendering logic 730 may not appear in some printers.

The printer 700 may also include a print image forming mechanism 740 configured to generate a print image onto print media from the print-ready image. The print image forming mechanism 740 may vary based on the type of the printer 700 and may include a laser imaging mechanism, other toner-based imaging mechanisms, an ink jet mechanism, digital imaging mechanism, or other imaging reproduction engine. A processor 750 may be included that is implemented with logic to control the operation of the printer 700. In one example, the processor 750 includes logic that is capable of executing Java instructions. Other components of the printer 700 are not described herein but may include media handling and storage mechanisms, sensors, controllers, and other components involved in the imaging process.

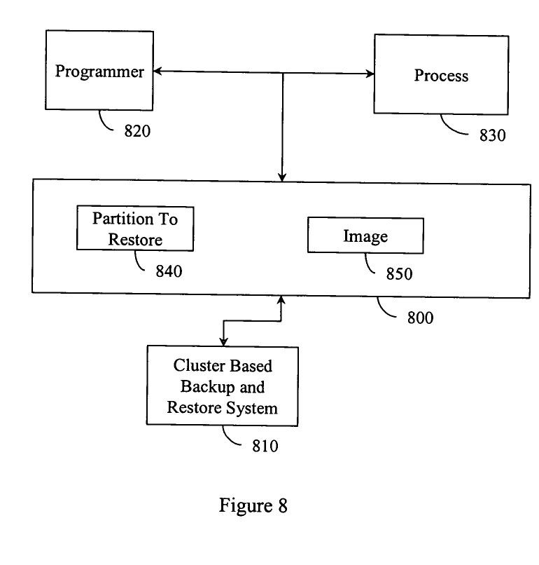

Referring now to FIG. 8, an application programming interface (API) 800 is illustrated providing access to a system 810 for producing a cluster-based backup image and/or restoring a partition on a hard disk drive from a cluster-based backup image. The API 800 can be employed, for example, by programmers 820 and/or processes 830 to gain access to processing performed by the system 810. For example, a programmer 820 can write a program to access the system 810 (e.g., invoke its operation, monitor its operation, control its operation) where writing the program is facilitated by the presence of the API 800. Rather than programmer 820 having to understand the internals of the system 810, the programmer 820 merely has to learn the interface to the system 810. This facilitates encapsulating the functionality of the system 810 while exposing that functionality.

Similarly, the API 800 can be employed to provide data values to the system 810 and/or retrieve data values from the system 810. For example, a process 830 that processes cluster-based backup image metadata can provide the metadata to the system 810 via the API 800 by, for example, using a call provided in the API 800. Thus, in one example of the API 800, a set of application programming interfaces can be stored on a computer-readable medium. The interfaces can be employed by a programmer, computer component, logic, and so on to gain access to a system 810 for producing a cluster-based backup image and/or restoring a partition on a disk drive from a cluster-based backup image. The interfaces can include, but are not limited to, a first interface 840 that communicates a data concerning a partition to restore, and a second interface 850 that communicates a data concerning a cluster-based backup image.

Thus, in one example, a set of application programming interfaces may be embodied on a computer-readable medium for execution by a computer component in conjunction with producing a cluster-based image backup and/or restoring a partition from a cluster-based image. The set of APIs may include, for example, a first interface for identifying a partition on a hard disk drive for which a cluster-based backup image is to be written onto the hard disk drive and a target partition on the hard disk drive in which the cluster-based backup image is to be placed. The set of APIs may also include, for example, a second interface for identifying a cluster-based backup image on the hard disk drive from which a partition on the hard disk drive can be restored and a target partition on the hard disk drive to be restored.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or”.herein is the inclusive, and not the exclusive use. See, Bryan A. Gamer, A Dictionary of Modern Legal Usage 624 (2d. Ed. 1995).

1. A computerized cluster-based backup method, comprising:
selecting a source partition on a hard disk drive, where a cluster-based backup image of the source partition will be produced and stored in a target partition on the hard disk drive;
obtaining a boot record for the source partition;
examining the boot record to determine a value for one or more file system parameters for a file system stored in the source partition;
calculating one or more values for one or more source partition metadata parameters from the one or more file system parameters and one or more source partition parameters;
writing a cluster-based backup image header data structure to the target partition, where the cluster-based backup image header data structure includes one or more of, the source partition metadata parameters, the file system parameters, and the source partition parameters;
selectively manipulating one or more bits in a volume bitmap associated with the source partition, where the bits are associated with one or more files that are not to be included in the cluster-based backup image;
identifying, by accessing the volume bitmap, one or more clusters in the source partition to be included in the cluster-based backup image; and
for the one or more clusters:
reading a cluster from the source partition; and
writing the cluster to the cluster-based backup image.

2. The method of claim 1, where the cluster-based backup image is created at a rate of more than five hundred megabytes per minute.

3. The method of claim 1, where the target partition is in the source partition.

4. The method of claim 1, where the target partition is not in the source partition.

5. The method of claim 1, where the boot record is obtained by reading the first sector from the source partition.

6. The method of claim 1, where the file system parameters include one or more of, a file system type, a file system size, and a cluster size.

7. The method of claim 1, where the cluster-based backup image header data structure includes one or more of, a header length field, a format version field, an original file name field, a partition cluster count field, a backup image cluster count field, a volume bitmap bit count field, a cluster size field, a sector size field, and a partition type field.

8. The method of claim 1, where the files that are not to be included in the cluster-based backup image include one or more of, a hiberfil.sys file, a pagefile.sys file and a ghost file.

9. The method of claim 1, where the boot record is obtained using a WinPE process.

10. The method of claim 1, where the boot record is examined using a WinPE process.

11. The method of claim 1, where the cluster-based backup image header data structure is written to the target partition using a WinPE process.

12. The method of claim 1, where the volume bitmap is accessed using a WinPE process.

13. The method of claim 1, where the cluster is read from the source partition using a WinPE process.

14. The method of claim 1, where the cluster is written to the cluster-based backup image using a WinPE process.

15. A computer-readable medium storing processor executable instructions operable to perform a method, the method comprising:
selecting a source partition on a hard disk drive, where a cluster-based backup image of the source partition will be produced and stored in a target partition on the hard disk drive;
obtaining a boot record for the source partition using a WinPE process;
examining the boot record using a WinPE process to determine a value for one or more of, a file system type, a file system size, and a cluster size associated with a file system stored in the source partition;
calculating one or more values for one or more source partition metadata parameters from one or more source partition parameters and one or more of, the file system type, the file system size, and the cluster size;
writing a cluster-based backup image header data structure to the target partition using a WinPE process, where the cluster-based backup image header data structure includes one or more of, the source partition metadata parameters, the source partition parameters, the file system type, the file system size, and the cluster size;
selectively manipulating, using a WinPE process, one or more bits in a volume bitmap associated with the source partition, where the bits are associated with one or more files that are not to be included in the cluster-based backup image;
identifying, by accessing the volume bitmap, one or more clusters in the source partition to be included in the cluster-based backup image; and
for the one or more clusters:
reading a cluster from the source partition, using a WinPE process; and
writing the cluster to the cluster-based backup image, using a WinPE process.

16. A computerized method for producing a cluster-based backup image of a source partition on a hard disk drive, comprising:
retrieving one or more source partition parameters from a boot data structure associated with the source partition;
accessing a volume bitmap associated with the source partition to facilitate identifying one or more clusters to be included in the cluster-based backup image; and
producing the cluster-based backup image by:
writing to a target partition a cluster-based backup image metadata data structure configured to store partition metadata; and
for one or more clusters in the source partition:
selectively reading a cluster based, at least in part, on information stored in the volume bitmap;
writing the cluster to the target partition; and
linking the cluster written to the target partition to the cluster-based backup image metadata data structure to facilitate restoring the source partition from the target partition.

17. The method of claim 16, where the source partition parameters include one or more of, a file system type, a file system size, and a cluster size.

18. The method of claim 16, where the boot data structure comprises a boot record.

19. The method of claim 16, where the volume bitmap is accessed using a WinPE process.

20. The method of claim 16, where the target partition is in the source partition.

21. The method of claim 16, where the target partition is not in the source partition.

22. The method of claim 16, where one or more clusters are read from the source partition in order using a WinPE process.

23. The method of claim 16, where one or more clusters are written to the target partition in order using a WinPE process.

24. A computer-readable medium storing processor executable instructions operable to perform a method for producing a cluster-based backup image of a source partition on a hard disk drive, the method comprising:
retrieving one or more of, a file system type, a file system size, and a cluster size associated with a file system stored on the source partition from a boot record associated with the source partition;
accessing, using a WinPE process, a volume bitmap associated with the source partition to facilitate identifying one or more clusters to be included in the cluster-based backup image; and
producing the cluster-based backup image by:
writing, using a WinPE process, to a target partition, a cluster-based backup image metadata data structure configured to store partition metadata; and
for one or more clusters in the source partition:
selectively reading, in order, using a WinPE process, a cluster based, at least in part, on information stored in the volume bitmap;
writing, in order, using a WinPE process, the cluster to the target partition; and
linking the cluster written to the target partition to the cluster-based backup image metadata data structure to facilitate restoring the source partition from the target partition.

25. A computerized partition restoration method, comprising:
identifying a partition to restore on a hard disk drive;
locating one or more cluster-based backup images from which the partition can be restored, where the one or more cluster-based backup images are located on the hard disk drive;
selecting a cluster-based backup image from which the partition will be restored;
reading a cluster-based backup image header data structure from the cluster-based backup image to obtain one or more of, a partition parameter, and a file system parameter;
writing one or more partition parameters to a boot record associated with the partition;
writing one or more file system parameters to the boot record associated with the partition;
resetting one or more bits of a volume bitmap associated with the partition; and
for one or more clusters in the cluster-based backup image:
reading a cluster from the cluster-based backup image;
writing the cluster to the partition; and
updating the volume bitmap to include the written cluster in a set of active clusters in the partition.

26. The method of claim 25, where the cluster-based backup image is located in the same partition as the partition to restore.

27. The method of claim 25, where the cluster-based backup image is located in a different partition than the partition to restore.

28. The method of claim 25, where the file system parameters include one or more of, a file system type, a file system size, and a cluster size.

29. The method of claim 25, where one or more of, reading the cluster-based backup image header data structure, writing the partition parameters to the boot record, writing the file system parameters to the boot record, resetting the bits in the volume bitmap, reading a cluster, and writing a cluster are performed using a WinPE process.

30. The method of claim 25, where the partition to be restored includes one or more of, an NTFS file system, and a FAT32 file system.

31. A computer-readable medium storing processor executable instructions operable to perform a method for restoring a partition from a cluster-based backup image, the method comprising:
identifying the partition to restore on a hard disk drive, where the partition includes one or more of, an NTFS file system, and a FAT32 file system;
locating one or more cluster-based backup images from which the partition can be restored, where the cluster-based backup images are located on the hard disk drive and where the cluster-based backup images are located in one or more of, the same partition as the partition to be restored, and a different partition than the partition to be restored;
selecting a cluster-based backup image from which the partition will be restored;
reading, using a WinPE process, a cluster-based backup image header data structure from the cluster-based backup image to obtain one or more of, a partition parameter, a file system name, a file system size, a file system type, and a cluster size;
writing, using a WinPE process, one or more partition parameters to a boot record associated with the partition;
writing, using a WinPE process, one or more of, the file system name, the file system size, the file system type, and the cluster size to the boot record associated with the partition;
resetting, using a WinPE process, one or more bits of a volume bitmap associated with the partition to restore; and
for one or more clusters in the cluster-based backup image:
reading a cluster from the cluster-based backup image, using a WinPE process;
writing the cluster to the partition to restore, using a WinPE process; and
updating the volume bitmap to include the written cluster in a set of active clusters in the partition to restore.

32. A computerized method for restoring a partition on a hard disk drive from a cluster-based backup image stored on the hard disk drive, the method comprising:
clearing a volume bitmap associated with the partition to be restored;
clearing a partition metadata data structure associated with the partition to be restored;
reading one or more partition metadata parameter values from the cluster-based backup image;
writing one or more of the partition metadata parameter values to the partition metadata data structure; and
for one or more clusters in the cluster-based backup image:
reading a cluster from the cluster-based backup image;
writing the cluster to the partition to be restored; and
updating the volume bitmap to include the cluster written to the partition to be restored as part of the restored partition.

33. The method of claim 32, where the volume bitmap is accessed using a WinPE process.

34. The method of claim 32, where the cluster-based backup image is stored in the same partition as the partition to be restored.

35. The method of claim 32, where the cluster-based backup image is stored in a different partition than the partition to be restored.

36. The method of claim 32, where the cluster-based backup image includes one or more of, an NTFS file system, and a FAT32 file system.

37. A computer-readable medium storing processor executable instructions operable to perform a method for restoring a partition on a hard disk drive from a cluster-based backup image stored on the hard disk drive, the method comprising:
clearing, using a WinPE process, a volume bitmap associated with the partition to be restored;
clearing, using a WinPE process, a partition metadata data structure associated with the partition to be restored;
reading, using a WinPE process one or more of, a partition file system name, a partition file system type, a partition file system size, and a cluster size from the cluster-based backup image;
writing one or more of, the partition file system name, the partition file system type, the partition file system size, and the cluster size to the partition metadata data structure; and
for one or more clusters in the cluster-based backup image:
reading, using a WinPE process, a cluster from the cluster-based backup image;
writing, using a WinPE process, the cluster to the partition to be restored; and
updating the volume bitmap to include the cluster written to the partition to be restored as part of the restored partition.

38. A system, comprising:
a metadata logic configured to acquire a partition metadata that describes a hard disk drive partition to be backed up, and to write the partition metadata to a cluster-based backup image on the hard disk drive from which the hard disk drive partition can be restored; and
a data logic configured to access a volume bitmap associated with the hard disk drive partition to be backed up, to selectively read a cluster identified in the volume bitmap as being allocated to the hard disk drive partition to be backed up, and to write the cluster to the cluster-based backup image.

39. The system of claim 38, where the metadata logic is further configured to acquire a partition metadata from a cluster-based backup image where the partition metadata describes a hard disk drive partition to be restored, and to write the partition metadata to a data structure on the hard disk drive to which the hard disk drive partition will be restored; and
where the data logic is further configured to access a volume bitmap data associated with the hard disk drive partition to be restored from the cluster-based backup image, to selectively read a cluster from the cluster-based backup image, to write the cluster to the partition to be restored, and to update the volume bitmap to associate the written cluster with the partition to be restored.

40. The system of claim 39, where the cluster-based backup image is located in the same partition as the hard disk drive partition to be backed up.

41. The system of claim 39, where the cluster-based backup image is located in a different partition than the hard disk drive partition to be backed up.

42. The system of claim 39, where the partition metadata is acquired from a boot record associated with the hard disk drive partition to be backed up.

43. A system, comprising:
means for identifying a partition on a hard disk drive for which a cluster-based backup image is to be written onto the hard disk drive;
means for acquiring and writing to the cluster-based backup image a partition metadata that describes the partition on the hard disk drive; and
means for acquiring and writing to the cluster-based backup image a partition data comprising one or more used clusters in the partition on the hard disk drive.

44. A system, comprising:
means for identifying a cluster-based backup image on a hard disk drive from which a partition on the hard disk drive can be restored;
means for acquiring and writing a cluster-based backup image partition metadata to the partition to be restored; and
means for acquiring and writing to the partition to be restored a partition data comprising one or more clusters stored in cluster-based backup image.

45. In a computer system having a graphical user interface comprising a display and a selection device, a method of providing and selecting from a set of data entries on the display, the method comprising:
retrieving a set of data entries, where a data entry represents one of, a cluster-based image backup action and a cluster-based image restore action;
displaying the set of data entries on the display;
receiving a data entry selection signal indicative of the selection device selecting a selected data entry; and
in response to the data entry selection signal, initiating one of, a cluster-based image backup operation, and a cluster-based image restore operation associated with the selected data entry.

46. A computer-readable medium having stored thereon a data structure comprising:
a first field containing data representing a cluster-based image from which a partition on a hard disk drive can be restored; and
a second field containing metadata describing the cluster-based image stored in the first field.

47. A set of application programming interfaces embodied on a computer-readable medium for execution by a computer component in conjunction with performing one or more of, a cluster-based image backup, and a cluster-based image restore, comprising:
a first interface for identifying a partition on a hard disk drive for which a cluster-based backup image is to be produced and a target partition on the hard disk drive in which the cluster-based backup image is to be written; and
a second interface for identifying a cluster-based backup image on the hard disk drive from which a partition on the hard disk drive can be restored and a target partition on the hard disk drive to be restored.
